(19) United States
(12) Patent Application Publication
(10) Pub. No.: US 2007/0144460 A1
(43) Pub. Date: Jun. 28, 2007

(54) HYBRID SYSTEM OF FUEL CELL AND COMBUSTION ENGINE

(76) Inventors: Julika BLEIL, Hamburg (DE); Martin ARENDT, Hamburg (DE); Lars FRAHM, Halstenbek (DE); Andreas WESTENBERGER, Buxtehude (DE)

Correspondence Address: OSTROLENK FABER GERB & SOFFEN, 1180 AVENUE OF THE AMERICAS, NEW YORK, NY, 100368403, US

(21) Appl. No.: 11/613,275

(22) Filed: Dec. 20, 2006

Related U.S. Application Data
(60) Provisional application No. 60/753,270, filed on Dec. 22, 2005.

(30) Foreign Application Priority Data
Dec. 22, 2005 (DE) 10 2005 061 574.0

(51) Int. Cl. F02B 43/08

(52) U.S. Cl. 123/3

(57) ABSTRACT

A hybrid system contains a fuel cell and a combustion engine, whereby a nitrogen-enriched discharge air of the fuel cell is used for a combustion process in a combustion chamber of the combustion engine.

### REFERENCE TO RELATED APPLICATIONS

This application claims the benefit of the filing date of U.S. Provisional Patent Application No. 60/753,270 filed on Dec. 22, 2005, the disclosure of which is hereby incorporated by reference, and the German patent application DE 10 2005 061 574.0 filed on Dec. 22, 2005, the disclosure of which is hereby incorporated by reference.

### BACKGROUND OF THE INVENTION

The invention relates to a hybrid system comprising a fuel cell and a combustion engine.

Combustion engines yield nitrous oxide (NOx) as exhaust. Under the term NOx, for example, the gases nitrogen monoxide (NO) und nitrogen dioxide are (NO2) are included.

Nitrogen dioxide is a potent tear gas and effects the mucous membranes, airways, and impairs lung function. As a cause of acid rain, in addition, NOx damages vegetation, bodies of water, and soil.

### SUMMARY OF THE INVENTION

According to an exemplary embodiment of the invention the system (hybrid system) includes at least one fuel cell and a combustion engine, whereby discharged air enriched with nitrogen of the fuel cell is used for a combustion process in a combustion chamber of the combustion engine, in order to reduce a nitrous oxide content in exhaust produced by the combustion process.

In addition to thermal and electrical energy, fuel cells produce water (water vapor) and nitrogen-enriched air. The nitrogen-enriched air is used, according to an exemplary embodiment of the present invention, in order to increase the nitrogen content of an air supply to the combustion chamber of the combustion engine, whereby as exhaust, less nitrous oxide exists.

In particular, the cathode discharge air of the fuel cell including water portions may be conducted as supply air into the combustion chamber. The water portion of the cathode discharge air additionally reduces the nitrous oxide in the exhaust of the combustion chamber.

According to a further exemplary embodiment of the invention, the cathode discharge air of the fuel cell may be separated by a condenser into water and dry nitrogen-rich (oxygen-poor) air. The combustion engine, therefore, may be supplied with cathode discharge air with a reduced or even no water portion.

According to a further exemplary embodiment of the invention, the nitrogen-enriched discharge air is mixed with an external air supply, in order to lower the nitrogen portion of almost 90 vol % of the cathode discharge air, so that the combustion engine still has sufficient oxygen for combustion. The reduction of the nitrous oxide shows the greatest potential with 79-85 vol % of nitrogen in the air supply.

### BRIEF DESCRIPTION OF THE DRAWINGS

Next, the preferred embodiments of the invention will be described with reference to the accompanying drawings, whereby the same reference numerals designate the same components.

FIG. 1 shows a schematic view of a hybrid system according to a first exemplary embodiment of the invention; and

FIG. 2 shows a hybrid system according to a second exemplary embodiment of the invention.

### DETAILED DESCRIPTION OF THE EMBODIMENTS

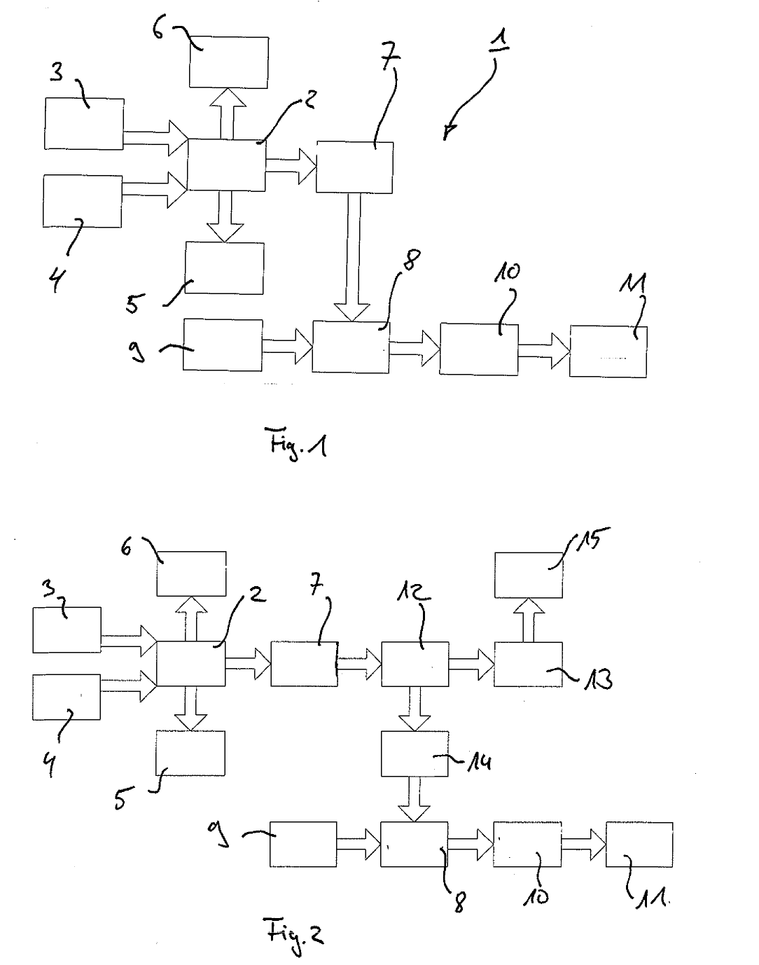

FIG. 1 shows a hybrid system 1 according to a first exemplary embodiment of the invention. The hybrid system 1 includes a fuel cell 2, to which air 3 and a fuel 4 are supplied, as shown schematically. The fuel cell 2 produces water or water vapor and nitrogen-enriched air 7 in addition to thermal energy 5 and electrical energy 6.

The nitrogen-enriched (and water-containing) air 7 is conducted to an air supply device 8. Since the nitrogen portion of the cathode discharge air of the fuel cell 2 may range almost to 90 vol %, preferably an external air supplier 9, which supplies air to the air supply device 8, lowers this portion, so that sufficient oxygen is provided for the combustion process.

According to this embodiment, as shown in FIG. 1, the air supply device 8 mixes the air 7 enriched with nitrogen and containing water with the external air, which is supplied, for example, from the external air supplier 9. The mixing takes place, such that preferably the mixed air produced by the air supply device 9 contains 79-85 vol % nitrogen. The air that is nitrogen-enriched in this manner is supplied by the air supply device 9 to a combustion engine (or into a combustion chamber of the combustion engine) 10.

By performing a combustion process in the combustion chamber of the combustion engine 10 with this type of nitrogen-enriched air, it is possible to yield an exhaust 11 with reduced nitrous oxides.

With Diesel engines, one determined, for example, that an air supply into the combustion chamber with an N2 portion of 79-82 vol % resulted in a reduction of the NOx in the exhaust of over 50%.

FIG. 2 shows a second exemplary embodiment of the hybrid system according to the present invention. The hybrid system 1 shown in FIG. 2 differs from the hybrid system shown in FIG. 1, in that in addition, a condenser 12 is used in order to separate the nitrogen-enriched and water vapor-containing air 7 from the fuel cell 2 into water 13 and dry nitrogen-enriched air 14. The water 13 separated off by the condenser 12 may be used for a further water use 15, for example.

The functions of the remaining components in FIG. 2 correspond respectively with those of the first exemplary embodiment, and therefore, are not described again.

The hybrid system 1 of the present invention may be used, for example, in motor vehicles, in particular in trucks with Diesel engines. Diesel engines generally have a increased nitrous oxide portion in the exhaust compared to gasoline engines. Thus, the possibility is offered with trucks, which have a fuel cell on board in order to generate on-board current, of conducting the cathode discharge air of the fuel cell into the combustion chamber of the Diesel engine. Thus, the production of nitrous oxides in the combustion chamber is reduced. The fuel cell additionally offers the advantage that the truck may generate current when the Diesel motor is turned off This is the case in particular at rest stops. Depending on the fuel of the fuel cell, little or even no emission of pollutants or greenhouse gases exists.

Although the invention was described above with reference to preferred exemplary embodiments, of course, modifications and changes are contemplated, without departing from the scope of protection of the invention.

For example, more than one fuel cell may be used in order to supply a combustion chamber of a combustion engine with nitrogen-enriched air.

In addition, the hybrid system may be used not only with Diesel engines of trucks, but also with normal gasoline engines, as far as the vehicle has a fuel cell on board.

It should be noted that the term ‘comprising’ does not exclude other elements or steps and the ‘a’ or ‘an’ does exclude a plurality. Also elements described in association with different embodiments may be combined.

It should be noted that the reference signs in the claims shall not be construed as limiting the scope of the claims.

### Reference Numeral List

1 hybrid system
2 fuel cell
3 air
4 fuel
5 thermal energy
6 electrical energy
7 nitrogen/water
8 air supply device
9 external air supply
10 combustion engine
11 exhaust
12 condenser
13 water
14 dry nitrogen-enriched air
15 water use

1. System containing a fuel cell and a combustion engine, wherein a nitrogen-enriched air of the fuel cell is supplied to an air supply device, which supplies the nitrogen-enriched air for a combustion process in a combustion chamber of the combustion engine, in order to reduce a nitrous oxide content in exhaust produced by the combustion process.

2. System of claim 1, wherein the air supply device reduces the nitrogen content of the nitrogen-enriched discharge air of the fuel cell, before this is supplied to the combustion chamber of the combustion engine.

3. System of claim 1, comprising a condenser, which separates the nitrogen-enriched discharge air of the fuel cell into water and dry nitrogen-rich air, in order to supply the dry nitrogen-rich air to the air supply device.

4. System of claim 1, whereby the nitrogen-enriched discharge air of the fuel cell is a cathode discharge air of the fuel cell.

5. System of claim 1, wherein the nitrogen-enriched air supplied to the combustion chamber of the combustion engine contains 79-85 vol % of nitrogen.

6. Use of a system according to claim 1 in a motor vehicle.
